(19) United States
(12) Patent Application Publication
(10) Pub. No.: US 2003/0213555 A1
(43) Pub. Date: Nov. 20, 2003

(54) Method and device for heat sealing plastic blister packs

(76) Inventors: Emidio Bernardi, Lasalle (CA); Mario Carlomusto, Kirkland (CA)

Correspondence Address: ELIAS C. BORGES, 1 EVA ROAD, SUITE 406, TORONTO, ON, M9C 4Z5, CA

(21) Appl. No.: 10/157,964

(22) Filed: May 15, 2002

(51) Int. Cl. B32B 31/00

(52) U.S. Cl. 156/292; 156/308.2; 156/379.8; 156/538

(57) ABSTRACT

An improved method and device for sealing together the edges of complimentary pairs of blister package elements is disclosed. The sealing device comprises a plurality of support housing for holding the blister package elements, the support housing mounted on a platform which in turn is coupled to an indexing drive. The drive is adapted to move the platform such that each support housing is passed sequentially through a plurality of stations. At least one of the stations is a loading station for loading thermoplastic blister package elements into the support housings. The device has a first platen mounted adjacent the platform at a heat sealing station positioned down stream of the loading station, the first platen is configured to press a heating plate towards the support housing positioned at the heat sealing station. The heating plate is adapted to be held at a temperature above the melting point of the blister package elements. A second platen is mounted adjacent the table at a cooling station positioned immediately after the heat sealing station. The second platen is adapted to press a cooling plate towards the support housing positioned at the cooling station. The cooling plate is adapted to be held at a temperature below the crystallization point.

### FIELD OF THE INVENTION

The invention relates to methods and devices for sealing blister packs of the type having double blisters and clamshells.

### BACKGROUND OF THE INVENTION

Blister packages are commonly used in retail. Blister packages generally comprise a flat cardboard backer sheet and a clear plastic compartment or blister adhered onto the backer sheet. The contents of the package, namely the product to be sold or promoted in conjunction with the blister pack, is generally contained in the clear plastic blister. The plastic sheet which carries the blister is usually formed by first softening a sheet of thermoplastic and then deforming it into the desired shape between the male and female haves of a mold. The plastic blister may then be adhered onto the cardboard backer sheet by means of an adhesive of some sort. While this method of manufacturing blister packs is effective, the step of adhering the blister pack to the cardboard sheet is relatively time consuming. Also, the cardboard backer sheet, being made of a non-water resistant material, can become compromised if the package is exposed to water. Furthermore, the entire package is relatively flimsy, and the packaging can be inadvertently opened during transport or storage.

A superior form of blister packaging is formed from two sheets of plastic, one or both sheets bearing the blister. A cardboard backer sheet is often inserted between the two sheets, the contents are placed in the blister and the sheets are then attached together by radio frequency welding the edges of the two sheets which overlap the backer sheet. While this method creates a blister pack which is stronger and more water resistant, the radio frequency welding of the thermoplastic sheets requires expensive radio frequency welding equipment. Furthermore, the radio frequency welding step tends to take a relatively long time, thereby representing a bottle neck in the process. As a result, the assembly of blister packaged articles tends to be relatively more expensive compared to other methods of packaging.

### SUMMARY OF THE INVENTION

In accordance with the present invention, there is provided a device for sealing together the edges of complimentary pairs of blister package elements made of a thermoplastic material having a melting point and a crystalizing point. The sealing device comprises a movable platform upon which a plurality of support housings are mounted, each support housing configured to receive the complimentary pairs of blister package elements. An indexing means is coupled to the platform and is adapted to move the platform in an indexed manner such that each support housing is passed sequentially through a plurality of stations. At least one of the stations being a loading station for loading thermoplastic blister package elements into the support housings positioned therein. The device has a first platen mounted adjacent the platform at a heat sealing station positioned down stream of the loading station, the first platen having a heating plate, the first platen configured to press the heating plate towards the support housing positioned at the heat sealing station. The hot plate is adapted to be held at a temperature above the melting point. A second platen is mounted adjacent the table at a cooling station positioned immediately after the heat sealing station, the second platen having a cooling plate, the second platen being configured to press the cooling plate towards the support housing positioned at the cooling station. The cooling plate is adapted to be held at a temperature below the crystallization point.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a top perspective view of an indexing blister packaging assembly device made in accordance with the present invention for carrying out the method of the present invention.

FIG. 2. is a bottom perspective view of the device shown in FIG. 1.

FIG. 3. is a cross-sectional view of a receiving element portion of the present invention.

FIG. 4. is a cross-sectional view of a receiving element shown in FIG. 3 showing the blister portion of a blister pack inserted.

FIG. 5. is a cross-sectional view of a receiving element shown in FIG. 4 showing an item to be packaged inserted into the blister portion.

FIG. 6. is a cross-section view of a receiving element shown in FIG. 5 showing a backer sheet inserted into the blister portion.

FIG. 7. is a cross-sectional view of the receiving element shown in FIG. 6 showing the plastic backer portion of the blister pack inserted into the blister portion.

FIG. 8. is a cross-sectional view of the receiving element shown in FIG. 7 showing the heating plate portion of the invention aligned above the receiving element.

FIG. 9. is a cross-sectional view of the receiving element shown in FIG. 8 showing the heating plate sealing the two halves of the blister pack together.

FIG. 10. is a cross-sectional view of the receiving element shown in FIG. 9 showing the cooling plate portion of the invention cooling the sealed blister pack.

FIG. 11. is a cross-sectional view of a finished blister packaged item.

In the drawings like characters of reference indicate corresponding parts in the different figures.

### DETAILED DESCRIPTION OF THE INVENTION

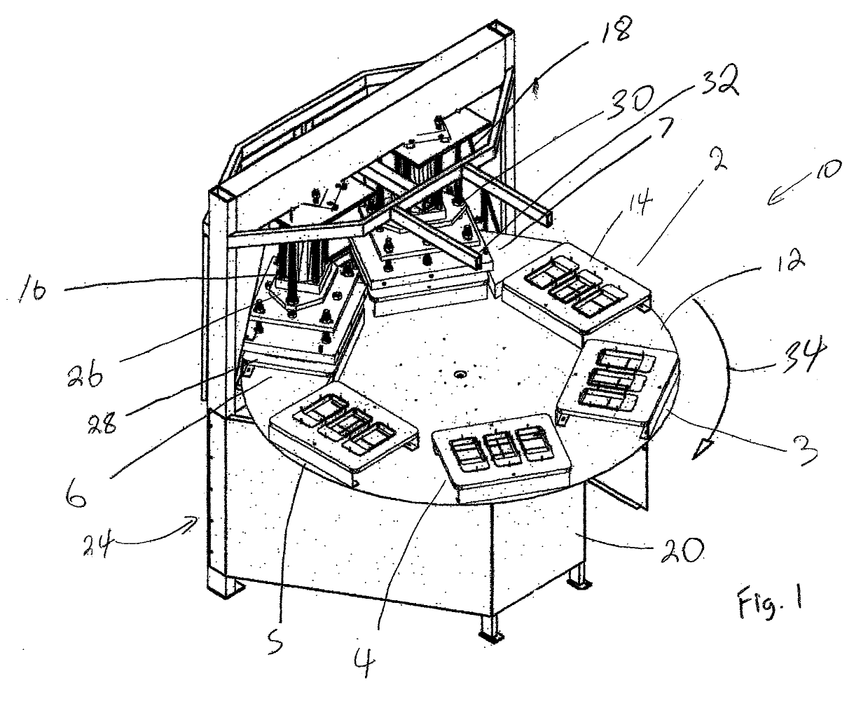

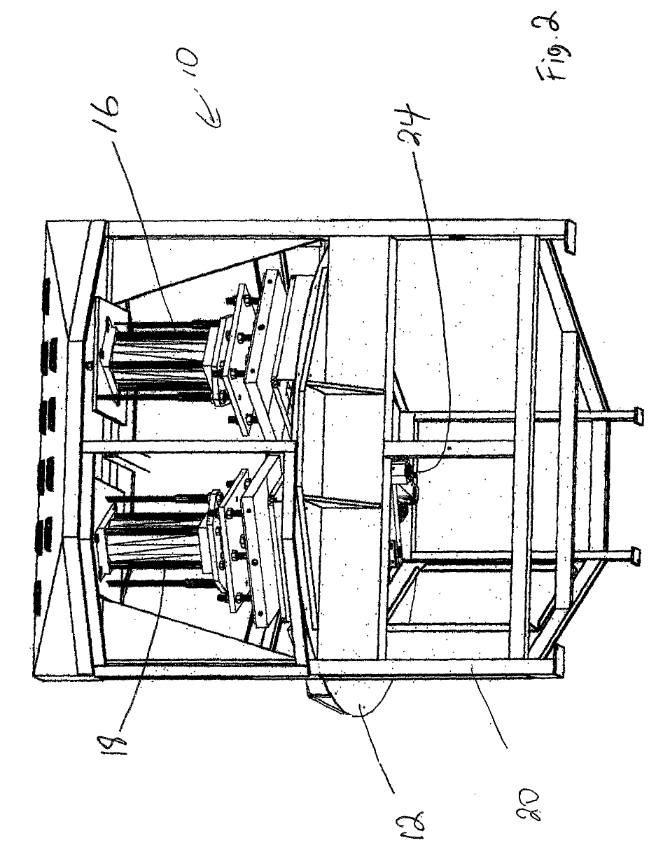

Referring firstly to FIGS. 1 and 2, a packaging device for assembling and sealing blister packs is shown generally as item 10 and consists of a rotatable platform table 12, a plurality of support housings 14, heating platen 16, cooling platen 18, table housing 20 and an indexing rotating means (see item 24, FIG. 2.). Heating platen 16 consists of platen 26 having heating plate 28. Cooling platen 18 consists of platen 30 having cooling plate 32. Indexing means 24 is adapted to rotate table 12 in the direction shown by arrow 34 such that each support housing 14 is moved sequentially through stations 2, 3, 4, 5, 6, and 7 in an indexed manner. In station 6, a support housing 14 is positioned directly beneath heating plate 28, while in station 7 the support housing is position directly beneath cooling plate 32. Heating platen 16 is adapted to press heating plate 28 against support housing 14 when the support housing is in station 6. Cooling platen 18 is adapted to press cooling plate 32 against support housing 14 when the support housing is in station 7.

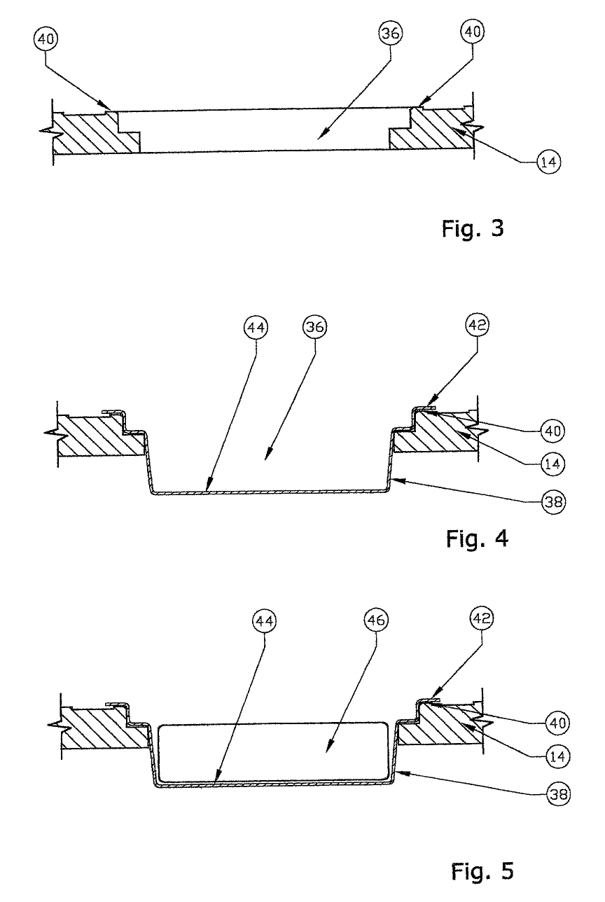

Referring now to FIGS. 3 and 4, support housing 14 is adapted and configured to support blister pack elements 38 in the correct orientation for sealing, and is provided with cavity 36 which is configured to receive the blister pack element. Shoulder portions 40 are circumferentially disposed about cavity 36 and is dimensioned and configured to receive edges 42 of blister pack element 38. Blister pack element 38 will have a bulbous blister portion 44, which is dimensioned and configured to contain an article when the blister package is fully assembled. Cavity 36 is dimensioned to receive bulbous portion 44. Preferably, cavity 36 is dimensioned to conform so closely to blister pack element 38 that when inserted into the cavity, the blister pack element is oriented with edges 42 securely within shoulder portions 40.

Referring now to FIGS. 3, 4 and 5, the first steps of the method of the present invention shall now be described. A blister pack element 38 is inserted into cavity 36 such that edges 42 of the blister pack element is supported by shoulder portions 40. Preferably, the insertion of the blister pack elements is an automated process performed by a stacking device (not shown). After insertion of the blister pack element, article 46 is inserted into bulbous portion 44. Again, the insertion of the articles is preferably an automated process.

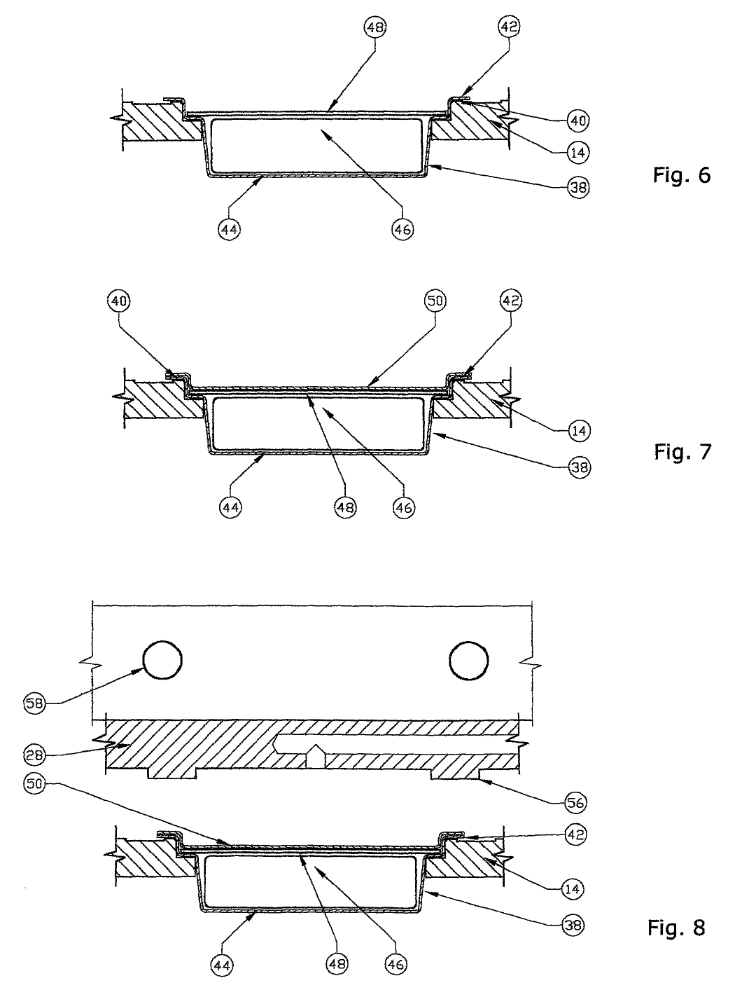

Referring now to FIGS. 6, 7 and 8, the next step in the process is to place a cardboard backer 48 into support housing 14 such that the cardboard backer is positioned on top of article 46. Cardboard backer 48 is dimensioned to be slightly narrower than blister pack element 38 such that when placed over item 46, edges 42 of the blister pack element extend beyond the edges of cardboard 48. Edges 42 of blister pack element 38 may be provided with indexing ridges or the like to ensure the correct placement of cardboard backer 48.

After cardboard backer 48 is properly inserted, blister pack element 50 is placed on top of the backer. Blister pack element 50 is dimensioned to be broader than backer 48 such that edge portions 52 of blister pack element 50 extends beyond the edges of the cardboard backer. When blister pack element 50 is properly positioned, article 46 and cardboard backer 48 will be sandwiched between blister pack elements 38 and 50. When blister pack element 50 is properly positioned, all of the components necessary to created the finished product are then ready for the final steps in the process, namely the sealing together of the two blister pack elements.

To seal blister pack elements 38 and 50 together, support housing 14 is first brought into alignment with hot plate 28. Hot plate 28 is provided with a lower surface 54 having ridges 56 which extend outwardly towards support housing 14. Hot plate 28 has electric resistance heating elements 58, which are adapted to heat ridges 56 to a temperature above the melting point of the thermoplastic forming blister pack elements 52 and 42. Ridges 56 of hot plate 28 are configured to conform to the outline of edges 52 of blister pack element 50 such that when the heating plate and the support housing are properly aligned and the hot plate is lowered, ridges 56 contact only edges 52 of the blister pack element.

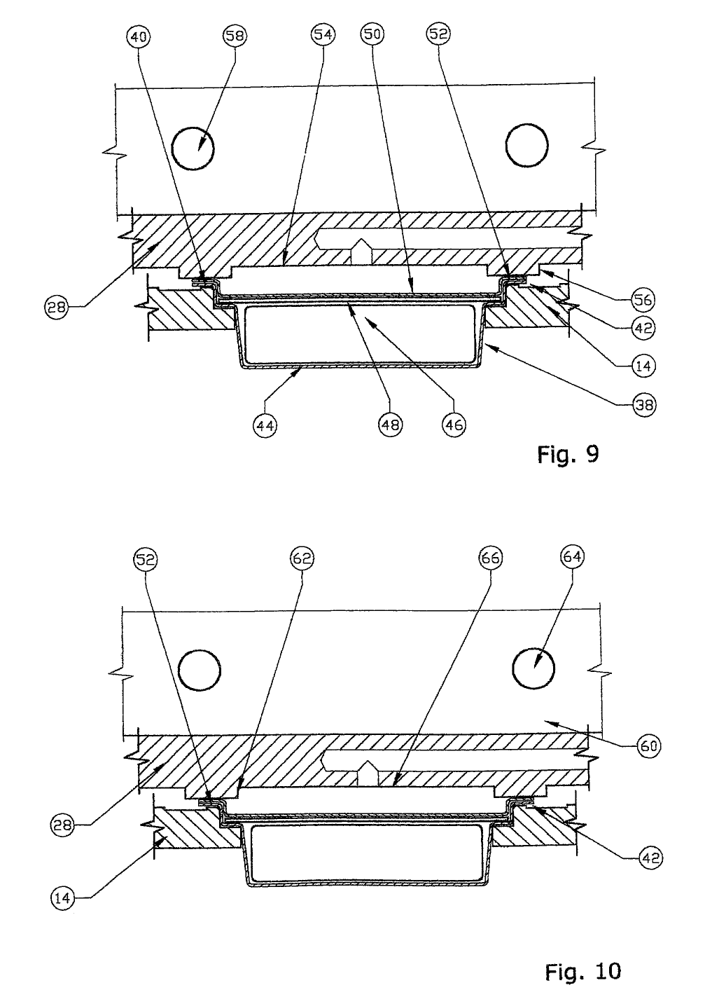

Referring now to FIGS. 9, 10 and 11, when hot plate 28 is pressed towards support housing 14 when the support housing and hot plate are aligned, ridges 56 squeeze edges 42 and 52 against shoulder 40. The heat from ridges 56 melt edges 42 and 52 together to form a unitary seal. Ridges 56 are held at a temperature sufficiently high to quickly melt edges 42 and 52 together, but lower than the charring temperature of the thermoplastic forming the blister pack elements. Of course, the higher the temperature of the ridges, the faster the thermoplastic melts, and the quicker the sealing. If the temperature of ridges 56 is too high however, then some charring of edges 42 and 52 may take place, resulting in an unsightly and potentially weaker seal. It is also important to keep ridges 56 in contact with edges 52 and 42 for a sufficiently long period of time to ensure complete melting of the edges. If edges 52 and 42 do not melt completely, then a poor seal may result. However, if ridges 56 remain in contact with the thermoplastic material for too long a period of time, then not only is the overall sealing process slowed down, but the thermoplastic may overheat and char. The temperature of ridges 56 and the contact time interval (i.e. the time interval wherein the ridges are in contact with the edges of the blister pack elements) can be optimized for the particular thermoplastic used. For blister pack elements made of PVC, PETG, PS, PP and many other thermoplastic materials (except PET), the temperature of ridges 56 should be between approximately 250° C. and 260° C. and the contact interval should be 3 to 4 seconds.

Since heating ridges 56 will also result in the rest of the hot plate reaching a higher temperature, it is important to ensure that blister pack element 50 does not accidently touch surface 54. To minimize the likelihood of inadvertent contact between surface 56 and the blister pack elements, surface 54 of heating plate 28 is dimensioned and configured to ensure that only ridges 56 make physical contact with blister pack element 50. While blister pack element 50 as illustrated is substantially flat, it will be appreciated that the shape and dimensions of both blister pack elements may be selected to conform to rounded or oddly shaped articles. Surface 54 may be made concave in order to accommodate oddly shaped blister pack elements.

When the contact interval has expired, heating plate 28 is moved away from support housing 14 and the support housing is then quickly positioned below cooling plate 60. Cooling plate 60 has ridges 62 which extend from surface 66 towards support housing 14. Ridges 62 are dimensioned and configured to correspond with edges 42 and 52 such that when housing 14 and cooling plate 60 are aligned and the cooling plate is lowered, the ridges make physical contact with the edges and squeeze the edges to shoulder 40. Cooling plate 60 is provided with channels 64, which in turn are connected to a cooling fluid circulation pump (not shown). The temperature of the circulating cooling fluid (not shown) is selected to hold the temperature of ridges 62 well below the crystallization temperature of the thermoplastic. With the temperature of ridges 62 held below the crystallization temperature, heat will be removed from molten edges 42 and 52, thereby forcing the edges to crystalize together into one solid mass. The solidified mass of thermoplastic forms a strong seal. To ensure that the molten edges are completely crystalized, cooling plate 60 remains in position for an interval of time sufficient to crystalize all of the molten thermoplastic. This crystallization time interval will vary depending on the temperature of the ridges and the crystallization temperature of the thermoplastic. It has been discovered that if ridges 62 are held at a temperature of between 5° C. and 10° C., the crystallization time interval will be approximately 3 to 3.5 seconds.

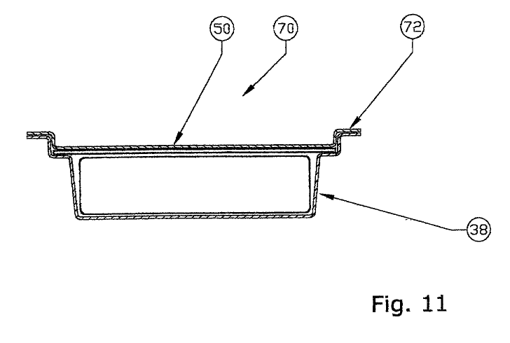

The finished product, shown in FIG. 11 as item 70 has a peripheral seal made from the melted edges of blister pack elements 50 and 38. The melting of the edges of the blister pack elements under pressure followed by the forced crystallization of the molten seal results in a strong seal.

Referring back to FIG. 1, packaging device 10 incorporates the method of the invention to quickly and efficiently assemble blister packaged items. Table 12 holds a plurality of support housings 14 and moves each housing from station to station in an indexed manner. The various components of the finished article, namely the blister pack elements, the backer sheet and the item to be stored in the blister packs can all be placed into housings 14 as the housings are moved from station 2 to station 5. For example, at station 2 the first half of the blister pack (not shown) may be inserted into housing 14. The housing is then moved to station 3 where an article is placed in the first blister pack half. At station 4, a cardboard backer may be inserted and at station 5 the second half of the blister pack is placed on top of the backer. At station 6, the edges of the blister pack halves are heat sealed together by platen 16. At station 7, the molten edges of the blister pack are then crystallized to finish the assembly. Indexing means 24 is adapted to ensure that housings 14 are moved correctly to ensure precise orientation of the housings and platens 16 and 18.

The present system has significant advantages over the prior art. Firstly, the use of a hot plate heated by electric heating elements is inexpensive to construct and easy to maintain. Furthermore, since those portions of the hot plate which actually contact the thermoplastic are held at the correct temperature, the melting step occurs relatively quickly compared to radio frequency techniques. Also, the use of a cooling plate held at a lower temperature greatly accelerates the crystallization step and also ensures uniform crystallization resulting in faster assembly times and greater quality control.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A method of heat sealing a blister package elements together of the type made from a thermoplastic material comprising the steps of:
a) bringing the two blister package elements together such that portions of the elements are in close proximity with each other, said portions to be melted together to form a seal,
b) pressing a hot plate to the two blister package elements, the hot plate having a heated portion configured to contact only the portions of the blister package elements which are to be melted together, the temperature of the heated portion of the hot plate selected to melt said portions of the blister package elements,
c) holding the hot plate to the blister package elements for a first period of time sufficient to melt together the blister package elements,
d) disengaging the hot plate from the blister package elements at the end of the first time period,
e) pressing a cooling plate to the blister package immediately after the hot plate is disengaged, the cooling plate having a cooling portion configured to contact those portions of the blister pack elements which have been melted together, the temperature of the cooling portion held to a temperature below the crystallization temperature of the blister package elements, and
f) holding the cooling plate to the blister package elements for a second period of time sufficient to fully crystalize the blister package elements.

2. The method of claim 1 wherein the temperature of the heated portions of the heating plate is between about 250° C. and about 260° C.

3. The method of claim 2 wherein the first time period is between 3 and 4 seconds.

4. The method of claim 3 wherein the temperature of the cooled portions of the cooling plate is between about 5° C. to about 10° C.

5. The method of claim 4 wherein the second time period is between about 3 to 3.5 seconds.

6. The method of claim 1 wherein the blister package elements are contained in a support housing during sealing, the support housing having support portions configured to support the portions of the blister package elements which are to be melted together.

7. The method of claim 6 wherein the support housing comprises a support member having a well portion configured to receive the blister package elements and a shoulder portion peripherally surrounding the well portion, the shoulder portion receiving the portions of the blister package elements which are to be melted together.

8. The method of claim 7 wherein the hot plate and support housing are configured to position the portions of the blister package elements which are to be melted together between the shoulder portions of the support housing and the heated portions of the hot plate.

9. The method of claim 8 wherein the cooling plate and support housing are configured to position the portions of the blister package elements which are to be melted together between the shoulder portions of the support housing and the cooled portions of the cooling plate.

10. A device for sealing together the edges of complimentary pairs of blister package elements made of a thermoplastic material having a melting point and a crystalizing point, the device comprising;
a) a movable platform upon which a plurality of support housings are mounted, each support housing configured to receive the complimentary pairs of blister package elements,
b) an indexing means for moving the platform in an indexed manner through a plurality of stations such that each support housing is passed sequentially from station to station,
c) a least one loading station for loading thermoplastic blister package elements into the support housings positioned therein,
c) a first platen mounted adjacent the platform at a heat sealing station positioned down stream of the loading station, the first platen having a heating plate, the first platen configured to press the heating plate towards the support housing positioned at the heat sealing station, the hot plate adapted to be held at a temperature above the melting point,
d) a second platen mounted adjacent the table at a cooling station, the second platen having a cooling plate, the second platen configured to press the cooling plate towards the support housing positioned at the cooling station, the cooling plated adapted to be held at a temperature above the crystallization point, and
e) the second station positioned immediately after the first station.

11. The device as defined in claim 10 wherein each support housing has a cavity adapted to receive the blister pack elements, the housing further having a shoulder circumferentially disposed about the cavity, the shoulder configured to support the edges of the blister pack elements when said elements are inserted into the support housing.

12. The device as defined in claim 11 wherein the heating plate has projecting heating ridges, the ridges being dimensioned and configured to correspond to the shoulders of the support housings such that the edges of the blister pack elements are squeezed between the shoulder and ridges when the heating plate and support housing are urged towards each other, the heating plate adapted to hold the temperature of the projecting ridges above the melting point.

13. The device as defined in claim 12 wherein the cooling plate has a cooling portion, the cooling portion being dimensioned and configured to correspond to the shoulders of the support housing such that the edges of the blister pack elements are squeezed between the shoulder and cooling portions when the cooling plate and support housing are urged towards each other, the cooling plate adapted to hold the temperature of the cooling portion below the crystallization point.

14. A device as defined in claim 10 wherein the indexing means moves the movable platform by rotating it.
